(19) United States
(12) Patent Application Publication
(10) Pub. No.: US 2025/0053572 A1
(43) Pub. Date: Feb. 13, 2025

(54) Data Transformation System

(71) Applicant: Bank of America Corporation, Charlotte, NC (US)

(72) Inventor: Brandon Lee, Jacksonville, FL (US)

(73) Assignee: Bank of America Corporation, Charlotte, NC (US)

(21) Appl. No.: 18/230,903

(22) Filed: Aug. 7, 2023

(51) Int. Cl. G06F 16/25; G06F 16/242

(52) U.S. Cl. CPC G06F 16/258

(57) ABSTRACT

Various aspects of the disclosure relate to automated conversion or transformation of data received from a plurality of sources, and of any format, into forms compatible as input to an application computing system. The data conversion platform identifies a format of an input data file or structure and imports characters, both printable and non-printable, from the input file and stores the imported characters as a string. The data conversion platform generates from the string data to an array of strings based on delimiters or other special characters. The data conversion platform applies a pattern model to the array string to identify patterns of data and stores matches as a second array of strings. The second array of strings is compared to a match file to identify bindings between input data and desired output data. These matches are then formatted as output data and communicated to the desired application for processing.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, to manage its computer systems efficiently, effectively, securely, and uniformly, and particularly manage how internal computer systems exchange information with external computer systems in providing and/or supporting different products and services offered by the organization. For example, external computing systems may communicate information in vastly different formats that may be used by an internal application when performing a function. Additionally, the external computing systems may communicate same or similar information in differing formats or presentations, such that the internal application may misinterpret or otherwise fail to import the data correctly. As such, a need has been recognized for systems and methods to import information efficiently and intelligently from a plurality of data types and formats and convert the data from each of the plurality of data types to a common data type usable by an internal computing system.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes systems and methods using various types and sizes of data records as input, and automatically parsing and converting the data record from any first format to one or more second formats that can be used within other computing system applications.

Various aspects of the disclosure relate to automated conversion or transformation of data received from a plurality of sources, and of any format, into a form compatible as input to an application computing system. A data conversion platform may be a stand-alone application or may be, at least in part, integrated into an application computing sytsem. The data conversion platform identifies a format of an input data file or structure and imports characters, both printable and non-printable, from the input file and stores the imported characters as a string. The data conversion platform generates from the string data to an array of strings based on delimiters or other special characters. The data conversion platform applies a pattern model to the array string to identify patterns of data and stores matches as a second array of strings. The second array of strings is compared to a match file to identify bindings between input data and desired output data. These matches are then formatted as output data and communicated to the desired application for processing.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for automated data transformation within an enterprise computing environment, in accordance with one or more aspects described herein;

FIG. 1B shows an illustrative computing platform enabled for automated data transformation within an enterprise computing environment, in accordance with one or more aspects described herein;

FIG. 2 shows illustrative data transformation system and method of operation of the data transformation system in accordance with one or more aspects described herein; and

FIG. 3 show an illustrative user interface associated with an application incorporating the data transformation system, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Enterprise organizations utilize one or more application computing systems to provide products and/or services to users. Often, the application computing systems utilize data received from a variety of sources, both internal and external to the organization. A format of the information may not be controllable because the information may be received from a third-party computing system using a pre-defined data format or may be received from an existing computing system that provides information for use by multiple other systems and cannot be changed. Further, because each application processing incoming data has different requirements, no standardized mappings of input data currently exists. Due to differences in the input data, often same or similar data may be received from different sources, but the applications may produce vitally different output based on the interpretation of the differently formatted data. Further, time, cost and/or software and/or hardware updates to improve the involved computing systems are impractical. As such, a need has been recognized for an automatic and intelligent system capable of processing input data, of any format, to produce output data capable of being processed by a desired computing system.

In some cases, a data transformation or conversion application may be packaged as an executable file (e.g., a Java) file that may be integrated into one or more different processes or application computing systems. Once opened, the data transformation application may display a user interface prompting selection of one or more input files, selection of certain options and/or selection of an output format or target computing system. In some cases, the input files, processing options, and/or an output format may be selected automatically via a configuration file. In some cases, processing of the input files may occur automatically, and in some cases a user may initiate processing of the input files either via interaction with the data transformation application or by selecting an application that is intended to process transformed input data. The data transformation may be completed within several seconds, where an option to view the output data may be provided by the data transformation application.

In an illustrative example, a third-party report analysis application computing system may integrate a data transformation application to facilitate quick and efficient analysis of third-party reports received from different sources. Because the different sources provide third-party reports in different formats, data transformation is required. When initiated, the data transformation application may open a user interface to allow selection of a third-party report file in any format (e.g., text document, spreadsheet document, PDF document, and/or the like). The user interface may also allow for customization of the processing such as by selecting options provided via a configuration file, where the options correspond to a particular analysis type to be performed by the third-party report analysis computing system after transformation of the input data file(s). Once configured, the user may trigger data transformation via selection of an input, where processing completes in a short time (e.g., 2 seconds, 3 seconds, 5 seconds or the like). In some cases, the data transformation application may open a window to allow user review of the transformed data before processing by the application system. In some cases, the data transformation application may automatically trigger operation of the application computing system upon completion of the data transformation process.

Based on the configuration file, the data transformation application may output all required information to allow for 100% completion of the process being performed by the computing system. In the illustrative example, the third-party report analysis computing system may convert all findings provided in a third-party report input as converted into a data format capable of efficient processing by the third-party report analysis computing system, completion of a checklist based on the converted data, notes, and/or several other documents needed for each assessment. Because of the efficient conversion of the input data into a second format easily processed by the third-party report analysis computing system, the third-party report analysis computing system, with the integrated data transformation application, is a highly powerful and dynamic system, producing completed reports in less 1% of the previous process times and at nearly 100% accuracy.

The data transformation and/or conversion application may include thousands of lines of code (e.g., Java, C#, C++, and the like) that may allow the application to identify and import all text from a plurality of file types (e.g., a PDF file, a text file, an image file, and the like). The data transformation and/or conversion application may analyze imported raw data for regular expression matches based on a configuration for a given output type, compare the matched data based on a configuration file list for string matches, and convert the regular expression match to the string match. In an illustrative example, a configuration file may cause matching from report findings identified in the input file and mapping to data fields associated with the target application operation. This same method may also be used to match the row and column of the required checklist so that it automatically completes the checklist. In some cases, the data transformation and/or conversion application may output multiple output files or data structures, such as the by providing an output file of a specified type and (e.g., a ‘notes.txt’ file) that may be populated with standardized text. Additionally, all conversions required by the associated application computing system may be placed into a file of a different (or same) format, such as an extensible markup language (XML) file that can be directly imported into the relevant application computing system, where multiple data points may have been dynamically extracted and interpreted/converted. Moreover, all text required in the application computing system may be dynamically generated to accurately portray the data contained in the converted data file or structure (e.g., results of a report).

In some cases, an input document may fail to be read directly, such as a failure to read a PDF document. The data transformation and/or conversion application may implement or otherwise incorporate OCR functionality that is very accurate and capable of reading scanned data files and even image files. This functionality may allow the application computing systems incorporating the data transformation and/or conversion application from being usable in 75% of cases to at least 97%, where the remaining 2.5-3% may apply to encrypted files requiring a key from the vendor for viewing. In such cases, the data transformation and/or conversion application may be extended with encryption and/or decryption functionality to automatically decrypt encrypted files to facilitate fast and efficient use of the encrypted data by the relevant application computing system. In some cases, any output data or other separately generated files output from the data transformation and/or conversion application may likewise be encrypted by the data transformation and/or conversion application upon creation.

The data transformation and/or conversion application may allow application development teams to incorporate the provided data conversion ability quickly and easily to allow for true input data agnostic operation. As a result, the data transformation and/or conversion application is organized and based on template detection with optional configuration file customizations. This structure allows the process to operate without a single point of failure for the application since customization for incorporation into other applications may be performed by individuals with knowledge of common programming skills (e.g., Java, C#, and the like) thus allowing for quick installation without costly time and/or hardware investments.

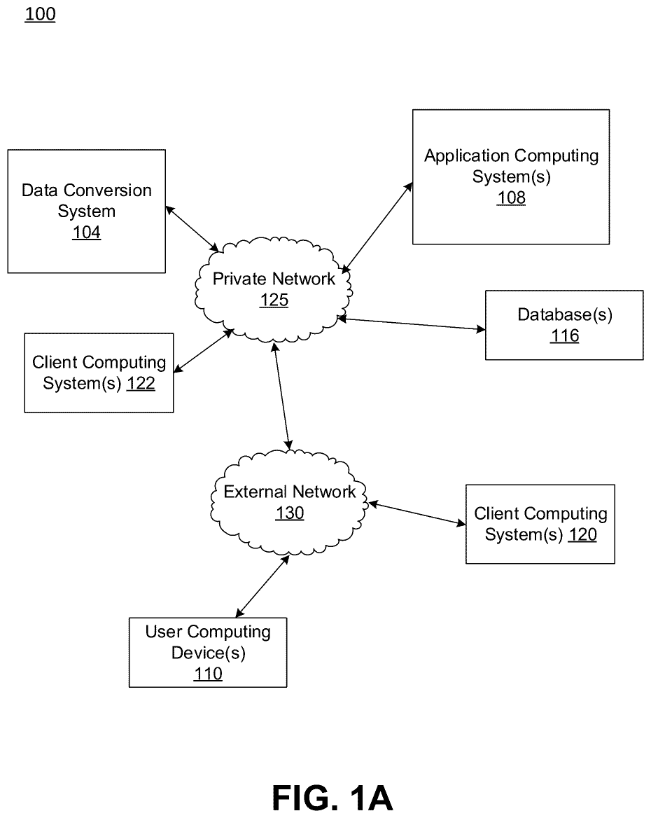

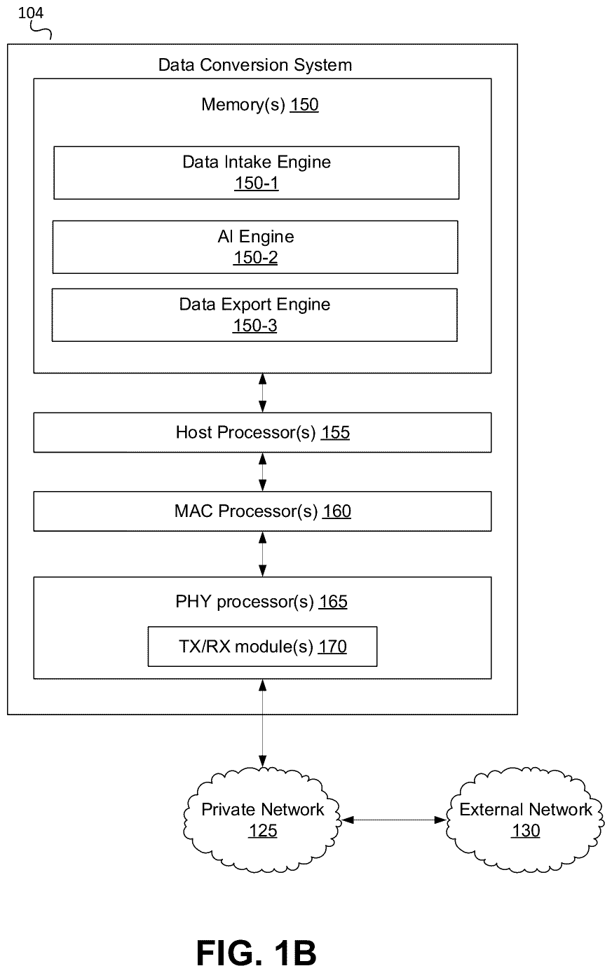

FIG. 1A shows an illustrative computing environment 100 for automated data transformation within an enterprise computing environment, in accordance with one or more arrangements. The computing environment 100 may comprise one or more devices (e.g., computer systems, communication devices, and the like). The computing environment 100 may comprise, for example, a data transformation computing system (e.g., a data conversion system 104), one or more application computing systems 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the data conversion system 104 as being a stand-alone system, the data conversion system 104 may be incorporated into another computing system, such as an application computing system or a client computing system.

The data conversion system 104 may comprise one or more computing devices and/or other computer components (e.g., processors, memories, communication interfaces) configured to perform one or more functions as described herein. Further details associated with the architecture of the data conversion system 104 are described with reference to FIG. 1B.

The application computing system 108 and/or the client computing system 122 may comprise one or more computing devices and/or other computer components (e.g., processors, memories, communication interfaces). In addition, the application computing system 108 and/or the client computing system 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing system 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The application computing system 108 and/or the client computing system 122 may comprise various servers and/or databases that store and/or otherwise maintain account information, such as financial account information including account balances, transaction history, account owner information, and/or other information. In addition, the application computing system 108 and/or the client computing system 122 may process and/or otherwise execute transactions on specific accounts based on commands and/or other information received from other computer systems comprising the computing environment 100. In some cases, one or more of the application computing system 108 and/or the client computing system 122 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application systems 108, such as via the services. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by data conversion system 104 For example, the database(s) 116 may store data conversion rules, data maps, data conversion models, data conversion dictionaries, and the like. In an arrangement, the database(s) 116 may be used for other purposes as described herein. In some cases, the client computing system 120 may write data or read data to the database(s) 116 via the services.

In one or more arrangements, the data conversion system 104, the application computing systems 108, the client computing system 122, the client computing system 120, the user devices 110, the databases 116, and/or the other devices/systems in the computing environment 100 may include any type of computing device capable of receiving input via a user interface, and communicating the received input to one or more other computing devices in the computing environment 100. For example, the data conversion system 104, the application computing systems 108, the client computing system 122, the client computing system 120, the user devices 110, the databases 116, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the data conversion system 104, the application computing systems 108, the client computing system 122, the client computing system 120, the user devices 110, the databases 116, and/or the other devices/systems in the computing environment 100 may, in some instances, be and/or comprise special-purpose computing devices configured to perform specific functions.

FIG. 1B shows an illustrative data conversion system 104 in accordance with one or more examples described herein. The data conversion system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The data conversion system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the data conversion system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the data conversion system 104 may be configured to execute machine readable instructions stored in memory 150. The memory 150 may comprise (i) one or more program modules/engines having instructions that when executed by the one or more processors cause the data conversion system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the data conversion system 104 and/or by different computing devices that may form and/or otherwise make up the data conversion system 104. For example, the memory 150 may have, store, and/or comprise a data intake engine 150-1, an artificial intelligence (AI) engine 150-2, a data export engine 150-3 and/or the like. The data intake engine 150-1 may have instructions that direct and/or cause the data conversion system 104 to perform one or more operations associated with loading one or more input data structures and/or data files, identifying a format of the one or more input data structures and/or data files, and importing the one or more input data structures and/or data files based on the identified formats. The AI engine 150-2 may have instructions that may cause the data conversion system 104 to process raw data imported by the data intake engine 150-1 and convert the data from an imported data format to a second data format capable of being processed by one or more application computing systems 108. The AI engine 150-2 may have instructions that may cause the data conversion system 104 to export the data from the data conversion system 104 to one or more different computing systems (e.g., the application computing systems 108).

While FIG. 1A illustrates the data conversion system 104 and/or the application computing systems 108, as being separate elements connected in the private network 125, in one or more other arrangements, functions of one or more of the above may be integrated in a single device/network of devices. For example, elements in the data conversion system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

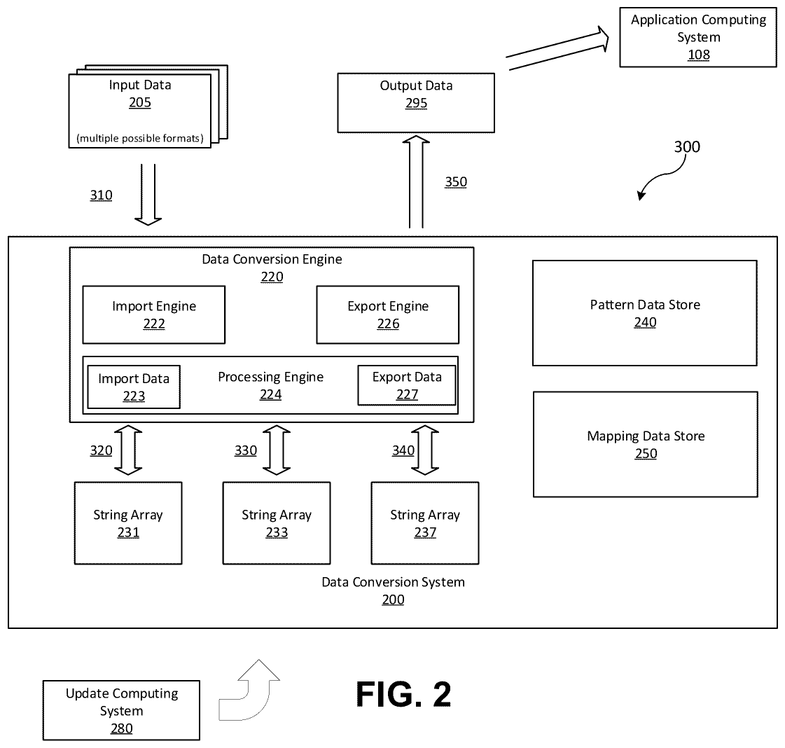

FIG. 2 shows illustrative data conversion system 200 and method 300 for operation of the data transformation system in accordance with one or more aspects described herein. The data transformation system (e.g., the data conversion system 200) may include a data conversion engine 200 comprising an import engine 220, a processing engine 224, and an export engine 226. The data conversion system 200 may further include one or more data stores, such as a pattern data store 240 and a mapping data store 250.

The import engine 222 of the data conversion engine 220 may, at 310, identify and load input data 205, where the input data may be in one or more different formats. For example, the input data may be a data object, such as a data structure, a data file, and/or the like. A data file may be one of a number of different formats, such as a text file, a document file, a PDF file, a spreadsheet file, a proprietary format file, an image file and/or the like. In some cases, the import engine 222 may identify a format of the input data 205 upon opening of the data object or data file. For example, the import engine may identify a text file, a comma separated file, a PDF file, a spreadsheet file based on file characteristics and/or information upon opening of the file. Similarly, the import engine may identify a format of a data structure or other data object upon access of the data structure or data object. The import engine 222 may identify and load text and/or alphanumeric characters, special characters, and the like, and identified within the input data 205 into the import data 223 as a character string.

In some cases, the import engine 222 of the data conversion engine 220 may automatically convert at least a portion of the input data 205 from a first format to a second format before import. For example, the import engine 222 may identify that the input data is an image file, such as a joint photographic experts group (jpeg) file, a tag image file format (tiff) file, and/or the like. In some cases, the import engine 222 may automatically begin identifying and loading characters from the input data 205 to the input data 223. The import engine 222 may keep a count of imported characters and compare that count to a threshold (e.g., 50 characters, 100 characters, and the like). If the count of imported characters is determined to be less than the threshold upon reaching the end of the file, the import engine 222 may identify the file as an image file. Upon identification of an image file, the import engine 222 may perform an optical character recognition (OCR) procedure on the file. In some cases, the import engine 222 may, before performance of the OCR procedure, convert the image file to grey scale, black and white, or other format to improve contrast for improved character recognition. Once converted, the import engine 222 may import characters identified in the file and store the characters as a string in the input data 223. In some cases, the import engine 222 may issue an error, warning, or other status message if a number of identified characters imported from an image file still falls below a same or similar threshold value.

At 320, the processing engine 224 of the data conversion engine 220 may convert the data string stored as input data 205 to a string array 231 as a list, where the conversion of the data string to an array element is based on identification of delimiters (e.g., an end of line character), or other data characteristics of the input string. At 330, the processing engine 224 may process the string array 231 based on regular expression information stored in the pattern data store 240. The regular expression information may include one or more expressions identified via training performed on training data sets associated with a particular application computing system 108 that has incorporated the data conversion system 200 to provide input for the application. The regular expressions may include phrases, sentences, word combinations, and the like that are associated with data useful to the application computing system operation. For example, a primary regular expression (e.g., a regex) may be applied to each entry in the string array 231 for every entry of a word, e.g., “Brandon likes to fly a kite”, the processing engine 224 may look at “Brandon likes to fly”, “likes to fly a kite”, “to fly a kite”, and the like, and when a match is found, the matches are entered into a string array 233. The processing engine 224 iterates through the large array and stores each match in the string array 233. As such, the string array 233 contains a large number of entries.

At 340, a pattern file or other configuration information, may be used by the processing engine 224. For example, a custom comma separated format may be used, where each line may include several values (e.g., words or phrases) separated by a comma. The processing engine 224 may load the mapping file line by line, where a first line may be loaded and split at a comma and may then have several (e.g., 3) entries. In some cases, the comma separated entry may include a first entry that corresponds to information that may be included in the raw data (e.g., report information), the second entry may be corresponding information (e.g., mapped information) used as input to the application computing system, and a third entry may be a Boolean flag identifying whether additional processing of the data entry is required (e.g., generation of rating or severity information) and if not present, the entry may be ‘n/a’. If the first entry of the pattern file matches an entry in the string array 233, that match results in a valid binding to information identified from the raw input data and is stored in the string array 237. The mapped information stored in string array 237 corresponds to valid mappings.

At 350, the valid bindings for the mapped information stored in string array 237 may be converted into export data 227, in a format capable of being read by the application computing system, such as an XML file format and may be exported by the export engine 226 as the output data 295. In some cases, the mapping information may be used by the export engine 226 to complete and/or generate a checklist corresponding to information to be input to the application computing system 108 to ensure that a complete output data set 295 has been generated based on the input data 205. The output data 295 may then be communicated to or otherwise used as input to the application computing system 108 for processing. If the application computing system 108 identifies input errors or completes processing successfully based on the inputs, feedback may be supplied by the data conversion system to retrain or otherwise improve operation of the process, such as by updating a pattern stored in the pattern data store or a mapping in the mapping data store. In some cases, the data conversion system 200 may be communicatively coupled to an update server 280 such that improved or updated code may be automatically communicated so that a most recent version of the data conversion system may be run. In short, the update server 280 may allow for dynamic updates to configuration and/or code files of the data conversion system 200 to ensure that the data conversion system 200 is the newest version every time it executes on any machine anywhere.

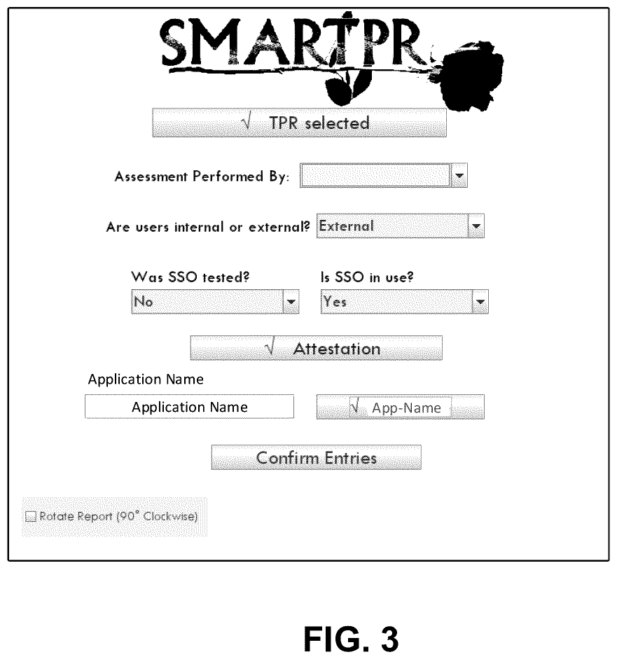

FIG. 3 show an illustrative user interface associated with an application incorporating the data transformation system, in accordance with one or more aspects described herein. For example, the user interface corresponds to an application interface for the data conversion system 200 integrated with an application computing system to process third party reports (e.g., TPRs). The user interface allows the user to select input data (e.g., a third party report), identify a source of the report, identify whether users are internal or external to the organization (e.g., configuring security and/or privacy controls integrated into the data conversion process and/or the application computing system), an application computing system to process the converted data, and/or the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a data conversion platform, comprising:
a processor; and
memory storing computer-readable instructions that, when executed by the processor, cause the data conversion platform to:
receive, via a network, a first input data comprising a file, wherein the file is in a first format of a plurality of formats corresponding to a first source computing system and comprising printable and non-printable characters;
import the first input data as a string based on identification of a format associated with the first source computing system;
generate, based on an input pattern file, a first array from pattern matches identified from the imported first input data;
generate, based on a configuration file, a second array comprising matches between an input information format and an output information format;
send, automatically via the network and based on generation of the second array, output data as an output file and in a format capable of being processed by an application computing system as second input data; and
trigger, automatically and based on an indication the output file is received at the application computing system, processing of the output file by the application computing system; and
the application computing system comprising:
a second processor; and
second memory storing second instructions that, when executed by the second processor, cause the application computing system to:
import, automatically upon receipt of the output file, the output file, wherein the output file is in a second format incompatible with the first format; and
perform an operation based on the second input data of the output file received from the data conversion platform.

2. The system of claim 1, wherein the data conversion platform is integrated, at least in part, within the application computing system.

3. The system of claim 1, wherein the first input data is incompatible with the application computing system.

4. The system of claim 1, wherein the instructions further cause the data conversion platform to:
identify a file format of the first input data; and
import, based on the file format, the printable and non-printable characters from the first input data.

5. The system of claim 1, wherein the instructions further cause the data conversion platform to:
identify a file format of the first input data; and
perform, based on an identification of an image file, optical character recognition to identify characters within the first input data; and
import identified characters from the first input data.

6. The system of claim 5, wherein the first input data is a pdf document.

7. The system of claim 1, wherein the output data is formatted as an extensible markup language (XML) file.

8. The system of claim 1, wherein the instructions further cause the data conversion platform to:
import characters from the first input data;
compare a count of imported characters to a threshold; and
perform, based on the count of imported characters not meeting the threshold, optical character recognition on the first input data.

9. The system of claim 8, wherein the instructions further cause the data conversion platform to convert the first input data to gray scale before performing optical character recognition.

10. A method comprising:
receiving, via a network, a first input data comprising a file, wherein the file is in a first format of a plurality of formats corresponding to a first source computing system and comprising printable and non-printable characters;
importing the first input data as a string based on identification of a format associated with the first source computing system;
generating, based on an input pattern file, a first array from pattern matches identified from the imported first input data;
generating, based on a configuration file, a second array comprising matches between an input information format and an output information format;
sending, automatically via the network and based on generation of the second array, output data as an output file and in a format capable of being processed by an application computing system as second input data; and
triggering, automatically and based on an indication the output file is received at the application computing system, processing of the output file by the application computing system; and
processing, by an application computing system the second input data received from a data conversion platform.

11. The method of claim 10, wherein the data conversion platform is integrated, at least in part, within the application computing system.

12. The method of claim 10, wherein the first input data is incompatible with the application computing system.

13. The method of claim 10, further comprising:
identifying a file format of the first input data; and
importing, based on the file format, printable and non-printable characters from the first input data.

14. The method of claim 10, further comprising:
identifying a file format of the first input data; and
performing, based on an identification of an image file, optical character recognition to identify characters within the first input data; and
importing identified characters from the first input data.

15. The method of claim 14, wherein the first input data is a pdf document.

16. The method of claim 10, wherein the output data is formatted as an extensible markup language (XML) file.

17. The method of claim 10, further comprising:
importing characters from the first input data;
comparing a count of imported characters to a threshold; and
performing, based on the count of imported characters not meeting the threshold, optical character recognition on the first input data.

18. The method of claim 17, further comprising converting the first input data to gray scale before performing optical character recognition.

19. Non-transitory computer readable media storing instructions that, when executed by a processor, cause a data conversion platform to:
receive, via a network, a first input data file, wherein the data file is in a first format of a plurality of formats corresponding to a first source computing system and comprising printable and non-printable characters;
import the first input data file as a string based on identification of a format associated with the first source computing system;
generate, based on an input pattern file, a first array from pattern matches identified from the imported first input data file;
generate, based on a configuration file, a second array comprising matches between an input information format and an output information format;
send, via the network, output data as an output file and in a format capable of being processed by an application computing system as second input data; and
trigger, automatically and based on an indication the output file is received at the application computing system, processing of the output file by the application computing system.

20. The non-transitory computer readable media of claim 19, wherein the instructions cause the data conversion platform to:
import characters from the first input data;
compare a count of imported characters to a threshold; and
perform, based on the count of imported characters not meeting the threshold, optical character recognition on the first input data.
